(19) United States
(12) Patent Application Publication
(10) Pub. No.: US 2005/0060420 A1
(43) Pub. Date: Mar. 17, 2005

(54) System for decoding multimedia data and method thereof

(76) Inventor: Branko D. Kovacevic, Toronto (CA)

Correspondence Address: TOLER & LARSON & ABEL L.L.P., 5000 PLAZA ON THE LAKE STE 265, AUSTIN, TX, 78746, US

(21) Appl. No.: 10/660,438

(22) Filed: Sep. 11, 2003

(51) Int. Cl. G06F 15/16

(52) U.S. Cl. 709/231

(57) ABSTRACT

A system and method for processing multimedia data streams having unknown protocols is shown and discussed. A multimedia data stream having an unknown protocol is received by a multimedia processing system. The multimedia processing system attempts to process the multimedia data stream using a plurality of data stream protocols until the multimedia processing system is able to identify data packets of the received multimedia data stream.

### FIELD OF THE DISCLOSURE

The present disclosure relates generally to processing multimedia data and more particularly to identifying properties of the multimedia data.

### BACKGROUND

Digital data streams have become a popular medium for providing multimedia data to consumers. Digital multimedia systems offer a potential for improved video and audio quality over related analog multimedia systems. As the consumer market is adopting digital multimedia, several forms of multimedia sources have risen. Consumers are capable of receiving multimedia data over data networks, such as the Internet, using multimedia-streaming technology. Multimedia devices, such as Digital Versatile Disk (DVD) players, can be used for playback of multimedia data from recorded media. Multimedia data can also be received from broadcast network sources, such as from digital satellite, digital television broadcast, and digital television cable systems.

Multimedia data can be provided in the form of International Organization for Standardization/ International Electro technical Commission (ISO/IEC) 11172-2 multimedia streams, also referred to as Motion Picture Experts Groups 1 (MPEG-1) multiplexed streams. The structure of MPEG-1 multiplexed streams is shown in prior-art FIG. 1. MPEG-1 multimedia streams are temporally subdivided into separate packets, such as packets 30, 35 and 44. Packets are serialized and collections of packets are sent in packs, such as packs 10, 11, and 12. The receipt of an end code 13 terminates a collection of packs. Each pack includes a start code 21 to uniquely identify the pack, a system clock reference 22, a system header 23 and zero or more packets, such as packets 30, 35, and 44. A packet start code 40, having 32 bits and including a start code prefix 41 and a stream identifier (ID) 42, is used to identify a multimedia stream to which a particular set of packet data, such as packet data 49 associated with packet 35, belongs. The MPEG-1 standard supports both fixed and variable packet lengths. Accordingly, a packet, such as packet 35 can include a packet length 43. The packet header can also include a few stuffing bytes 45, a systems target decoder (STD) buffer scale 46, and STD buffer size 47 and time stamps 48. The time stamps 48 may include decoding time stamps (DTS) and/or presentation time stamps (PTS) 48.

Multimedia streams may be formatted into transport streams according to an ISO/IEC 138181-1 standard, also referred to as the MPEG-2 standard. The MPEG-2 standard is based on 188-byte packets. MPEG-2 packets can exceed 188 bytes, to have a total length of 204 or 208 bytes, with the addition of optional forward error correction (FEC) codes. The structure of the MPEG-2 transport layer is shown in prior-art FIG. 2. Separate transport packets, such as transport packets 51, 52 and 53, are serially provided as part of a transport packet stream 50. Individual packets, such as packet 52, are recognized by a synchronization (sync) byte 54. The sync byte 64 is represented by a start code having a hexadecimal value of 0x47. Packet 52 also includes a packet error flag, transport error indicator 55. A payload unit start indicator 56 identifies the start of a packetized elementary stream (PES) packet in the payload of a particular packet. A transport priority indicator 57 identifies a priority for a particular transport packet. A 13-bit packet identifier (PID) 58 is used to distinguish between a plurality of multimedia streams that can be carried inside of a transport packet payload. A packet includes a transport scrambling control indicator 59, an adaptation field control indicator 60, to indicate an existence of an optional adaptation field associated with a particular packet, and a continuity counter 61, used to detect lost transport packets. An optional adaptation field 62, includes a length indicator, a byte representing several flags, optional data, information content and optional padding. The data content includes program clock references (PCR) that provide stream timing information. A payload associated with an MPEG-2 transport packet includes one or more MPEG-2 PES packets containing elementary audio and video stream data.

A structure of an MPEG-2 program stream is shown in prior-art FIG. 3. Similar to MPEG-1 system layers, the MPEG-2 program stream (PS) 63 is organized into a collection of packs, such as pack 64, pack 65, and pack 66. Each pack is preceded by a pack header, such as pack header 76, associated with pack 64. The pack header 76 includes a pack start code 67, having a hexadecimal value of 0x000001BA, and is followed by two bits having a binary value of ‘10’. The pack header 76 also includes a 42-bit time base sample (SCR) 68 and a program multiplex rate 69. The pack header 76 can include an optional pack stuffing byte 71, prior to a system header 72 and a collection of one or more PES packets, such as PES packet 73, PES packet 74 and PES packet 75.

Multimedia streams may also be received in a format associated with video compact discs (VCD). VCD is a reproduction system for presentation of full motion pictures with associated audio through the use of a compact disc (CD) format. VCD is based on MPEG-1 standard for video and audio compression. MPEG audio and video tracks are organized in a collection of tracks on a VCD. MPEG-1 video pack data associated with VCD include 2312 bytes and audio pack data associated with VCD include 2292 bytes. Both audio and video packs include an MPEG-1 start code having a hexadecimal value of 0-x000001BA. Audio and video packs can also include a system header, having a system header start code with a hexadecimal value of 0-x000001BB. MPEG-1 VCD video and audio sectors include an end code having a hexadecimal value of 0-x000001B9. VDC audio and video sectors having an end code are allowed to have only one MPEG-1 audio, or video, packet and/or one padding packet. The total length of a last packet in a video sector is limited to 2308 bytes, followed by a 4-byte end code. The total length of a last packet in an audio sector is limited to 2288 bytes followed by a 4-byte end code and 20 zero bytes.

Multimedia streams can be received as part of a Digital Satellite System (DSS) format used to broadcasting or digital storage media (DSM) applications. DSS formatted transport layers are based on 130-byte fix length packets. Each packet includes a 2-byte header (DSS prefix) followed by 128 bytes of payload (transport block).

Multimedia streams can be provided in a format associated with digital versatile discs (DVD). Prior-art FIG. 4 illustrates the DVD video object structure. DVD is based on video object (VOB) structures, such as VOB 77. VOB 77 includes a plurality of cells, cell 78, 77 and 80. Each cell, such as cell 81, includes a collection of VOB units (VOBU), such as VOBU 81, VOBU 82 and VOBU 83. Within each VOBU, such as VOBU 81, are interweaved packs, such as navigation pack 84, video pack 85 and audio pack 86. Each pack, such as navigation pack 84, is based on a fixed length of 2048 bytes and includes an MPEG pack header. The pack header includes a start code 88, a system clock 89, a program multiplex rate 90 and a stuffing length indicator 91. A pack also includes stuffing bytes 97 and an integer number of video, audio, sub-picture, presentation control information (PCI) or data search information (DSI) packets, such as packet 93 and packet 94. Each DVD packet resembles MPEG PES header structures followed by elementary stream in the payload. A DVD packet, such as packet 93, includes a start code 95, a stream identifier 96, a packet length indicator 97, miscellaneous data 98 (including a sub-stream identifier), and packet dependent data 99, such as PCI, DSI, video, audio, and sub-picture data.

DVD audio data contains 0 to 8 streams, with audio codec 3 (AC-3), MPEG-1, MPEG-2 or linear pulse code modulation (LPCM) compression (source coding) and an audio bit rate ranging from 32 Kbps to 6.144 Mbps. DVD AC-3 audio source coding has a sampling frequency of 48 KHz, a sample size of up to 20 bits, a bit-rate ranging from 64 to 448 Kbps, and a channel combination as 1/0, 2/0, 3/0, 2/1, 2/2, 3/1, and 3/2. In comparison, DVD MPEG audio source coding has a sampling frequency of 48 KHz, a sample size of up to 20 bits, layer II MPEG-1 or a backwards compatible (BC) matrix mode MPEG-2, a bit rate of 64-192 Kbps in MPEG-1 mono mode, 64-384 Kbps in MPEG-1 stereo mode, and 64-912 Kbps in MPEG-2 matrix mode. DVD MPEG audio source coding includes extension streams of 5.1 channel and 7.1 channel with channel combination as 1/0, 2/0, 2/1, 2/2, 3/0, 3/1, 3/2, or 5/2. DVD LPCM audio source coding has a sampling frequency of 48 or 96 Kbps, a sample size of 16, 20 or 24 bits, and 1 to 8 channels.

While several multimedia sources exist for consumers to access digital video data, several of the multimedia sources have their own protocols for carrying the digital multimedia data packets. For example, different sources use different data packet lengths for carrying information. To provide a consumer with access to a variety of multimedia data streams, some multimedia systems include means for processing a variety of multimedia stream protocols. However, to process a particular multimedia stream, the multimedia systems are told of the data stream type or the protocol to process the data stream. Therefore, either a multimedia device must provide a signal indicating a protocol of the multimedia data stream, or a user must provide information to the multimedia system indicating a particular protocol to be used. Having the user to provide information to the multimedia system on every type of multimedia stream to be processed burdens the user and reduces an ease and comfort for the user to use the multimedia system and access a multimedia program. Content from the multimedia stream archived in a file system may be recognized by using agreed file extensions; however, there are no standardized file extensions widely accepted in the consumer electronics field. Even so, there is still a problem of content format recognition when a multimedia stream is sourced from a live broadcasting network.

From the above discussion, it is apparent that an improved method of processing received multimedia streams is desired.

### BRIEF DESCRIPTION OF THE DRAWINGS

Specific embodiments of the present disclosure are shown and described in the drawing presented herein. Various advantages, features and characteristics of the present disclosure, as well as methods, operations and functions of related elements of structure, and the combination of parts and economies of manufacture, will become apparent upon consideration of the following description and claims with reference to the accompanying drawings, all of which form a part of this specification, and wherein:

FIG. 1 is a block diagram illustrating prior-art structure of an MPEG-1 system layer;

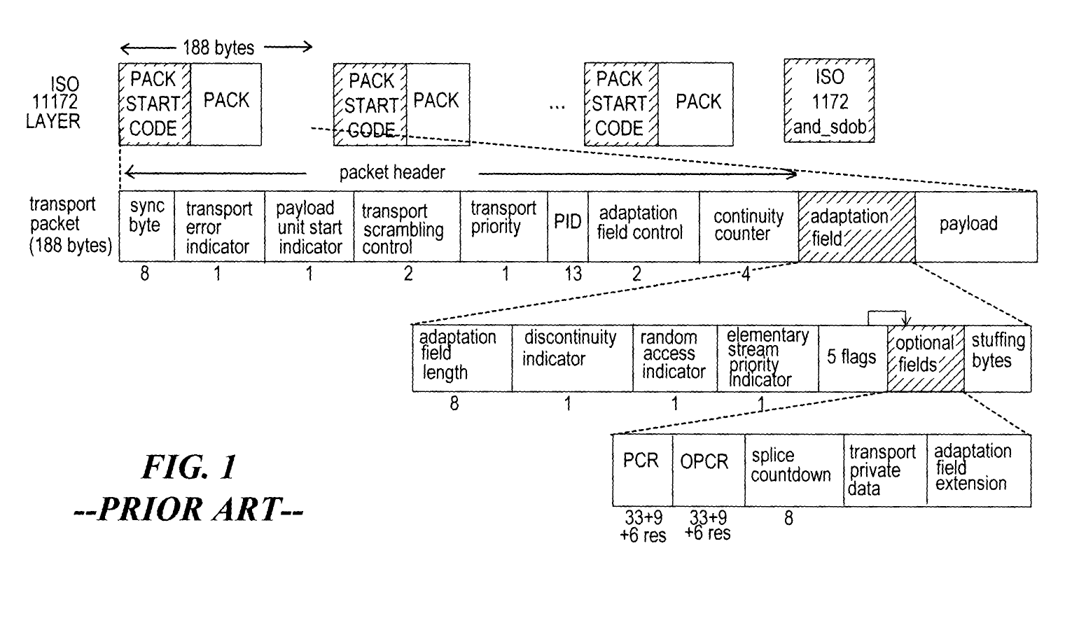

FIG. 2 is a block diagram illustrating prior-art structure of an MPEG-2 transport packet;

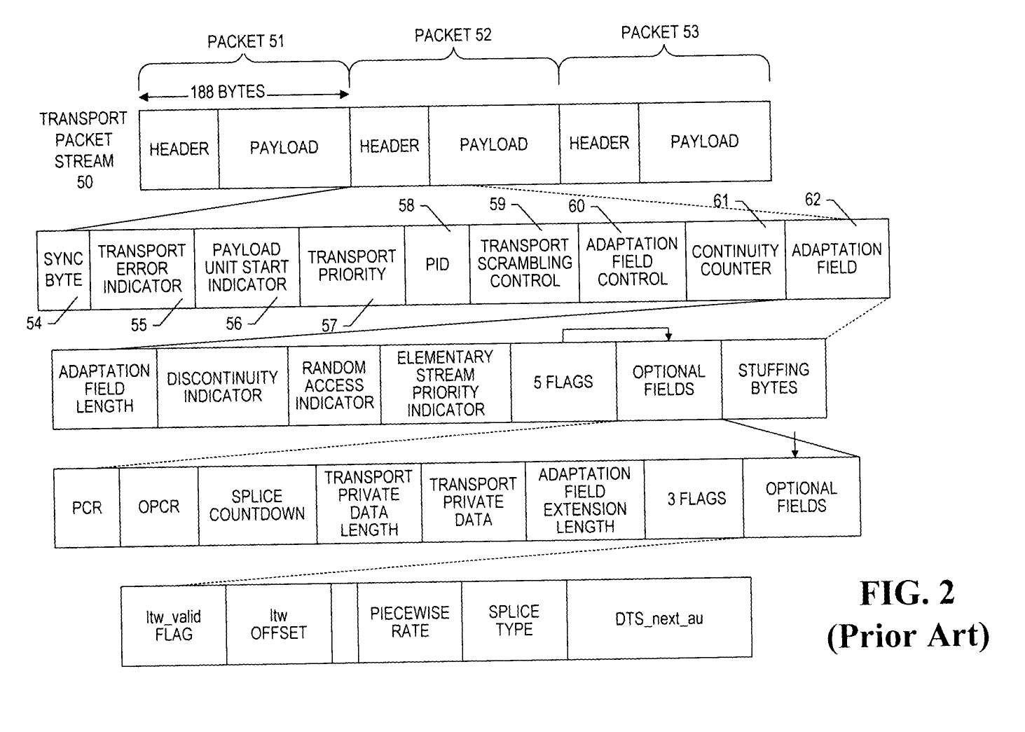

FIG. 3 is a block diagram illustrating prior-art structure of an MPEG-2 program stream;

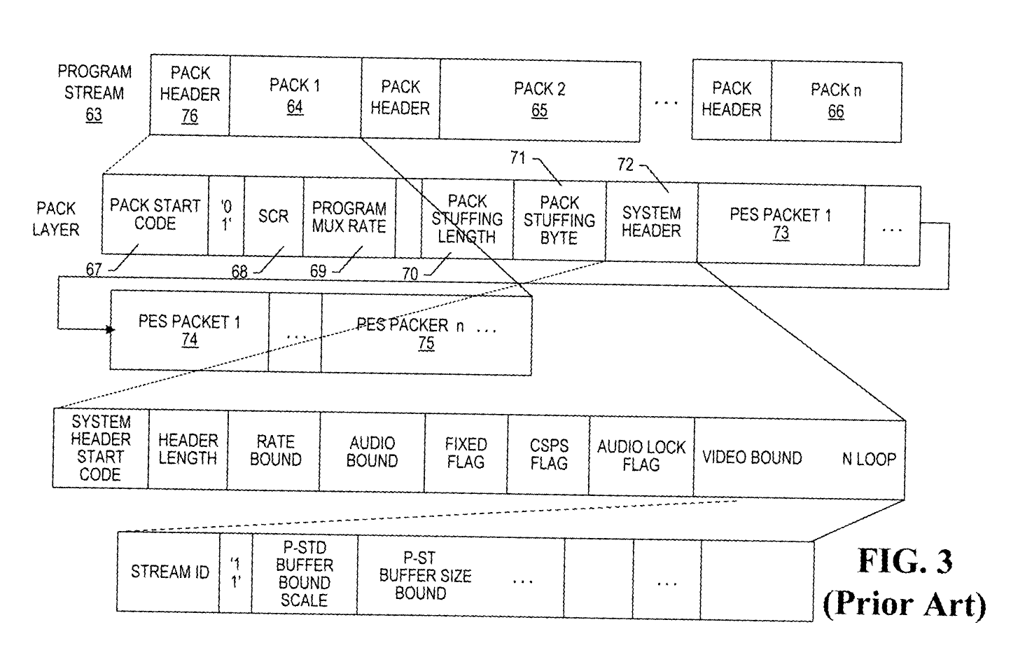

FIG. 4 is a block diagram illustrating prior-art structure of a DVD video object;

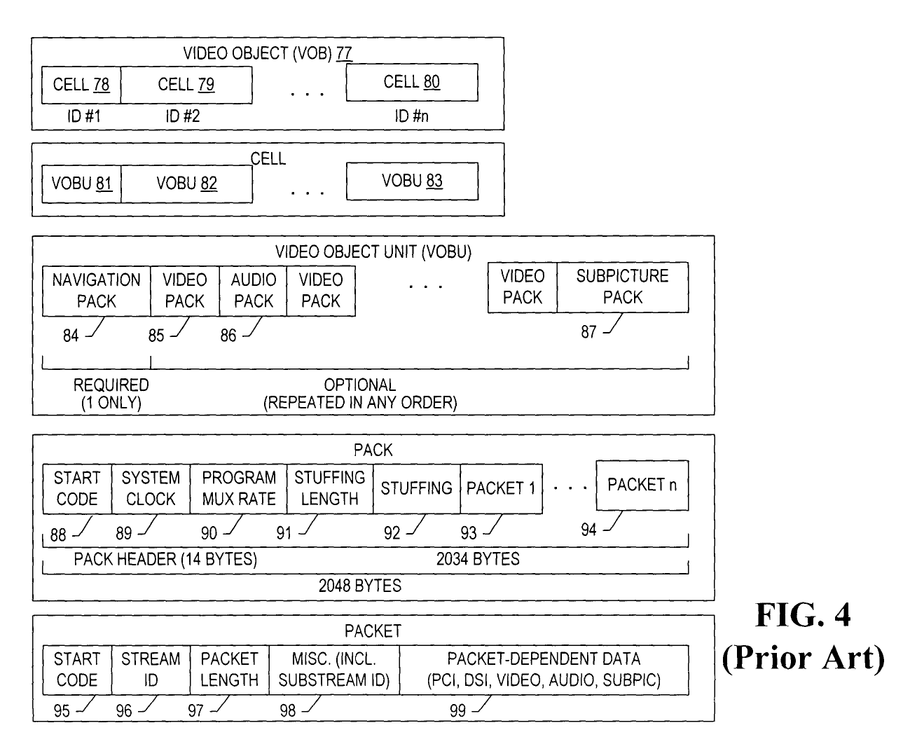

FIG. 5 is a block diagram illustrating a system for processing multimedia data, according to one embodiment of the present invention;

FIG. 6 is a flow diagram illustrating a method for processing different types of multimedia streams, according to one embodiment of the present invention;

FIG. 7 is a flow diagram illustrating a method for identifying a packet type of a received multimedia stream, according to one embodiment of the present invention;

FIG. 8 is a flow diagram illustrating a method of identifying properties of a received multimedia stream, according to one embodiment of the present invention;

FIG. 9 is a block diagram illustrating hierarchal levels for organizing identified program properties, according to one embodiment of the present invention;

FIG. 10 is a method identifying a method of identifying a type of a received multimedia stream, according to one embodiment of the present invention; and

FIG. 11 is a method of parsing MPEG-1 and MPEG-2 pack and program stream data, according to one embodiment of the present invention.

### DETAILED DESCRIPTION OF THE FIGURES

At least one embodiment of the present invention provides for a method of processing different types of multimedia streams. The method includes receiving a first data stream of multimedia data. The multimedia data includes a first protocol that is unknown to a system receiving the first data stream. The method includes determining, based on a first portion of the first data stream, the first protocol of the multimedia data. In one embodiment, the system receiving the first data stream includes a plurality of known multimedia data protocols. The system attempts different known protocols until a lock with the multimedia data of the first data stream is achieved. In one embodiment, upon determination of the first protocol, the system stores a second portion of the first data stream in memory. The second portion of the data stream can then be processed based upon the first protocol. The system is capable of receiving a second data stream of multimedia data, having a second protocol, different from the first protocol. The method includes determining, based upon a first portion of the second data stream, the second protocol. An advantage of at least one embodiment of the present invention is that a received data stream having an unknown protocol can be identified and processed.

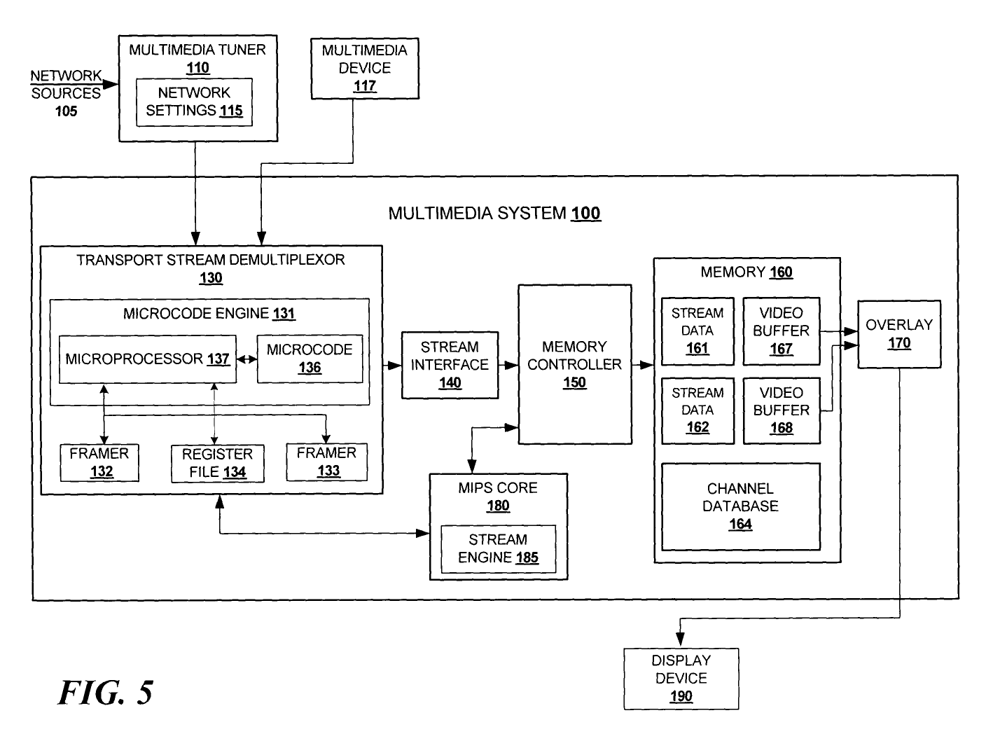

Referring now to FIG. 5, a block diagram illustrating a system for processing multimedia data is shown and referenced generally as multimedia system 100, according to one embodiment of the present invention. Multimedia system 100 processes multiplexed data streams from a plurality of multimedia sources, such as a multimedia tuner 110 and a multimedia device 117 for display on a display device 190. Multimedia system 100 includes a transport stream demultiplexor 130, a stream interface 140, a memory controller 150, memory 160, an overlay 170, and a microprocessor, such as a microprocessor without interlocked pipeline stages (MIPS) core 180.

Multimedia system 100 is capable of processing data streams from different types of multimedia sources. In the illustrated embodiment, multimedia system 100 receives and processes multiplexed data streams from multimedia tuner 110. Multimedia tuner 110 includes a system capable of selecting a multiplexed data stream from a single network source, or plurality of network sources 105. Multimedia tuner 110 can include a digital broadcast, digital cable, or digital satellite tuner used to provide a selected multiplexed data stream from a plurality of multiplexed data streams in network sources 105. The selection of a multiplexed data stream can be based on a user setting or preset network settings 115, stored in the multimedia tuner 110. In one embodiment, multimedia tuner 110 identifies a protocol of network sources 105 to process the selected multiplexed data stream from the network sources 105. The identified protocol can be predefined in network settings 115, or multimedia tuner 110 can attempt to process data from network sources 105 according to several known network protocols until a working protocol of network sources 105 is identified. In one embodiment the network protocol includes physical properties of a received signal, such as from network sources 105. The physical properties can include, but are not limited to, a modulation type, a carrier frequency, an applied forward error code, or a packet length. The network protocol can also include a set of active control signals used to source a data stream towards a particular decoding device or a multimedia file identifier. A multimedia file identifier may be provided if a network source is associated with a file system on a memory device, such as a hard disk, a compact disk (CD), a DVD, a blue ray disk, or other type of non-volatile storage, such as a flash memory file system.

Multimedia tuner 110 can provide a single or multiple sets of multiplexed data streams to the multimedia system 100. Multimedia system 100 can also process data streams from other devices, such as multimedia device 117.

Multimedia device 117 includes a multimedia data source, such as a digital versatile disk (DVD) player or a networked video streaming source, such as a streaming-multimedia source from the Internet. Multimedia data streams associated with the multimedia device 117 are received by the multimedia system 100. It should be noted that data streams provided by different sources, such as multimedia tuner 110 and multimedia device 117 can include different data protocols. For example, data streams associated with standard Motion Pictures Experts Group (MPEG) 2 format video data can be formatted in 108-, 204-, or 208-byte packets. Digital television and digital satellite data streams can be formatted differently, such as Direct-TV's 130-byte data packets. Similarly, data stream protocols associated with DVD data streams can be different from the standard MPEG-2 and digital television and satellite data streams. Multimedia system 100 is capable of detecting the different data protocols from the different sources, multimedia tuner 110 and multimedia device 117, and processing data streams from the different sources appropriately.

In the illustrated embodiment, the transport stream demultiplexor 130 receives multimedia data streams from the multimedia tuner 110 and the multimedia device 117. The transport stream demultiplexor 130 includes a microcode engine 131, which includes a micro-programmable sequencer, or microprocessor 137 and microcode 136. The microcode 136 includes commands for microprocessor 137. In one embodiment, microcode engine 131 is used for processing data packets from received multiplexed data streams until a proper data stream protocol is identified. Microcode engine 131 controls transport stream demultiplexor 130 to test several different data stream protocols and parameters for processing each of the data streams received from multimedia sources, multimedia tuner 110 and multimedia device 117. If a particular data stream protocol fails, a new protocol is attempted, until a matching protocol is identified. Accordingly, transport stream demultiplexor 130 can identify a protocol of a received data stream. Transport stream demultiplexor 130 includes framers 132 and 133 to generate data packets from the received multiplexed data streams, based on the protocols identified by the transport stream demultiplexor 130. For example, framer 132 can be used to frame packets based on a protocol associated with the multiplexed data stream from the multimedia tuner 110 and framer 133 can frame packets based on a protocol associated with data streams from the multimedia device 117, despite differences between the protocols of the received data streams.

In one embodiment of the present disclosure, exchange of control information between microprocessor 137 and MIPS core processor 180, and access to sampled data streams stored in a first-in-first-out (FIFO) buffer of framers 132 and 133, is achieved through register file 134. Register file 134 can be used to provide data associated with a stream lock or samples of a received stream to MIPS core 180.

Data streams formed into packets by the framers 132 and 133 of transport stream demultiplexor 130 are transferred to memory 260. In one embodiment, stream interface 140 includes a data buffer or a collection of data buffers to assist in the transfer of data stream packets from the transport stream demultiplexor 130 to memory 160. Several forms of data buffers, such as circular buffers, can be used to store and transfer the data stream packets to memory 160. Similarly, several data buffers or stream interfaces can be used in addition to stream interface 140 to transfer data associated with the received data streams. The data stream data is read from stream interface 140 and stored in memory 160, through a memory controller 180.

MIPS core 180 is used to process commands associated with a stream engine 185. The stream engine 185 includes commands for tracking and processing data associated with received data streams. In one embodiment, the stream engine 185 manages a channel database 164 in memory 160. The channel database 164 includes properties associated with received data streams, such as network information used to tune particular multiplexed data streams, multiplex information including protocols of received data streams, program information including data to identify individual programs and channels within the received data streams, elementary stream information including video and audio stream descriptors, and other information associated with the data streams. The MIPS core 180 represents a processor used to process commands associated with stream engine 185. In one embodiment, the MIPS core 180 represents a reduced instruction set computer (RISC) processor. Other forms of processors can be used to process the stream engine 185 without departing from the scope of the present invention.

In one embodiment, the stream engine 185 identifies the network information by communicating with an external tuner, such as multimedia tuner 110. The stream engine 185 can identify multiplex information through the transport stream demultiplexor 130. The stream engine 185 can store the multiplex information as a part of the channel database 164. Program and elementary stream information can be gathered by parsing stream data, such as stream data 162 and 162, associated with received data streams. For example, in one embodiment, the stream data 161 is associated with the data stream processed from the multimedia tuner 110. The stream engine 185 can access the packet protocol identified by the microcode engine 131 to assist in parsing information from the stream data 161. For example, video data stored as a part of stream data 161 can be parsed and stored in video buffer 167. Other information in the stream data 161, such as elementary stream information and program information can also be parsed form the stream data 161 by the stream engine 185 and stored as a part of the channel database 164. Stream data 162 includes data associated with the video stream received from the multimedia device 117. Stream engine 185 can assist in the parsing of video data stored as a part of stream data 162 to video buffer 168. Elementary stream information and program information can also be parsed from the stream data 162 and stored as a part of channel database 164.

In one embodiment, stream engine 185 assists in the processing of multimedia data by providing information stored in channel database 164 to other applications or drivers used to process data associated with the data streams 161 and 162. For example, upon future processing of multiplexed data streams from multimedia tuner 110, the stream engine 185 can provide the multiplex information stored in the channel database 164 to the transport stream demultiplexor 130 to assist in the identification of data packet protocols. Similarly, the stream engine 185 can provide network information stored in the channel database 164 to allow the multimedia tuner 110 to identify desired multimedia data streams of network sources 105. The stream engine 185 can also provide program information stored in channel database 164 to allow other programs and information associated with a particular stream data, such as stream data 161 and 162, to be identified and processed. Memory 160 includes a form of data storage associated with multimedia system 100. In one embodiment, memory 160 includes frame buffer memory, common to conventional multimedia processing systems. Accordingly, portions of frame buffer memory can be partitioned to store stream data associated with received data streams, such as stream data 161 and 162, channel database 164 and video buffer data, such as in video buffers 167 and 168. Other forms of memory, such as forms of random access memory (RAM), can be used in place of a frame buffer without departing from the scope of the present invention. In the illustrated embodiment, the video data stored in the video buffers 167 and 168 can be provided to overlay 170 for display on display device 190.

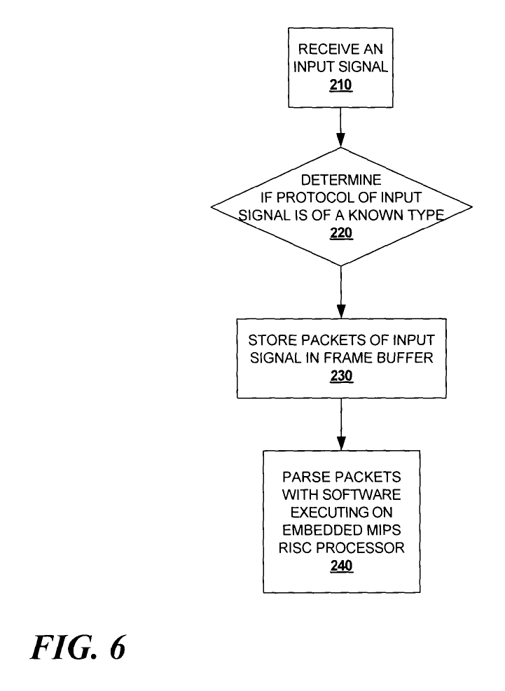

Referring now to FIG. 6, a flow diagram illustrating a method for processing different types of multimedia streams is shown, according to one embodiment of the present invention. In one embodiment, the steps describe a method of processing received multimedia streams, such as processing performed by transport stream demultiplexor 130 of FIG. 5 on received multiplexed data streams.

In step 210, an input signal is received. In one embodiment, the received input signal is associated with a data stream, such as a multiplexed multimedia data stream. The input signal can be received from an external multimedia source, such as a tuner (multimedia tuner 110 of FIG. 5), a multimedia device (multimedia device 117 of FIG. 5), such as a DVD player. Other multimedia sources, such as a data stream received from a networked multimedia streaming system, can be used to generate the input signal. As different sources can be used to provide the input signal, a protocol used to identify packets of the input signal, can be different for various sources.

In step 220, it is determined if a protocol of the input signal is of a known type. In one embodiment, a system performing the processing described in the flow of FIG. 6, includes information regarding various known protocols to be expected. The system attempts to match a known protocol to the received input signal. If processing of the input signal based on the known protocol is successful, the flow proceeds to step 230, to process the input signal according to the known protocol. If all known protocols are attempted and none of the known protocols match the protocol of the input signal, the flow returns to step 210 to re-attempt processing of the input signal, until a match can be identified. As the input signal can change, or another multimedia source can become available, the system can continue to attempt identifying the protocol of the input signal. Alternatively, the system can halt further processing when the protocol of the input signal does not match any known protocols. In one embodiment, successful processing of the input signal includes being able to identify data packets of the input signal using the selected protocol. Successful processing can also be based on whether a processing system component, such as transport stream demultiplexor 130, is capable of generating a lock based on processing of the input signal using the selected protocol.

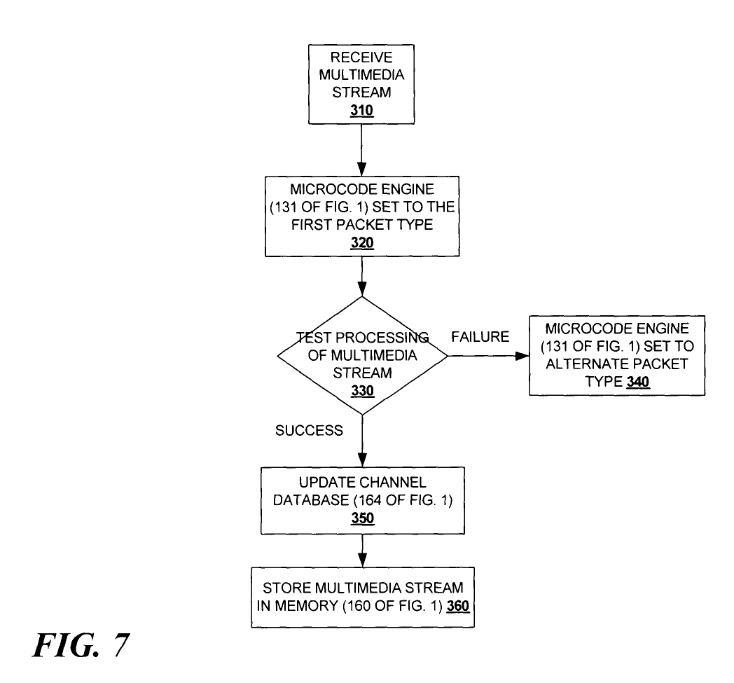

In step 230, the packets associated with the received input signal are stored in memory, such as in a frame buffer (memory 160). In step 240, the system parses the stored packets associated with the received input stream using a software MIPS. The packets are parsed based on the protocol of the received input stream identified in step 220. In one embodiment, the software MIPS provides information regarding the identified protocol to assist in parsing the packets. In one embodiment, software on MIPS stores information regarding the identified packet in a database (channel database 164). Other information regarding data parsed from the packets can also be stored in the database to assist in further processing of the received input signal. Processing performed to match the protocol of the received input signal to a known protocol can be better understood with reference to FIG. 7.

Referring now to FIG. 7, a flow diagram illustrating a method for identifying a packet type of a multimedia stream received by transport stream demultiplexor 130 of FIG. 5 is shown, according to one embodiment of the present invention. In step 310, transport stream demultiplexor 130 receives a multimedia stream. The multimedia stream can include a multiplexed data stream received from a multimedia source, such as multimedia tuner 110 or multimedia device 117 of FIG. 5. Packets of the multimedia stream can be organized into one of a plurality of protocols, based on a packet type used by the multimedia source.

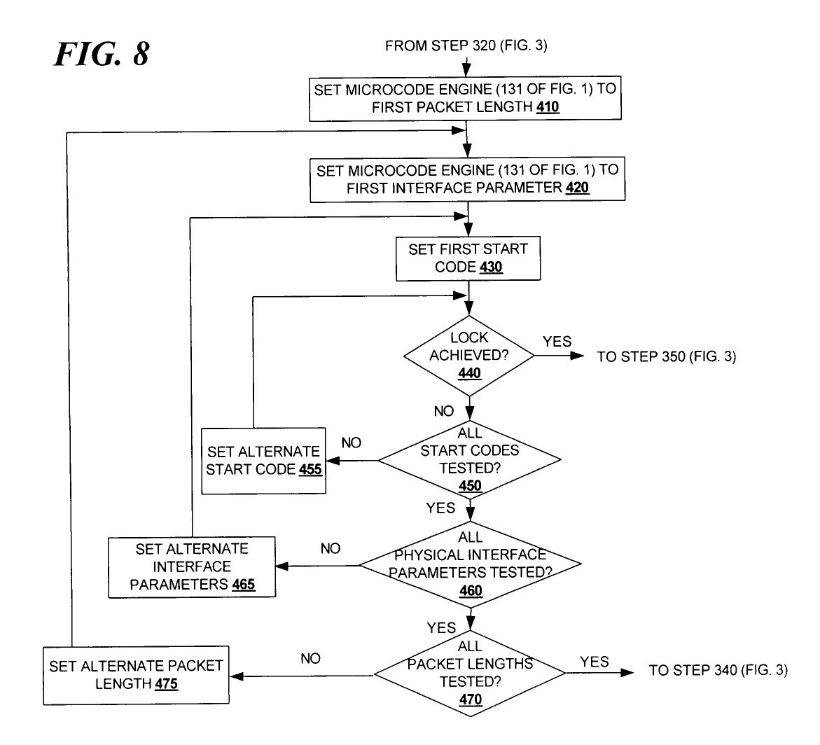

In step 320, the microcode engine 131 is set to a first packet type. The first packet type is selected from a plurality of known packet types programmed into the microcode engine 131. In one embodiment, a program of the microcode engine 131 identifies the first packet type to be used. In another embodiment, the packet type to be used is selected by an external component, such as MIPS code 180, providing commands for the microcode engine 131. In step 330, processing of the received multimedia stream is tested using the first packet type. Processing can include attempting to parse packets of the received multimedia stream using the first packet type. Further testing can include attempting altering other parameters associated with the first packet type to identify a particular protocol being used with the received multimedia stream. An example of further testing to identify unique protocol properties of the received multimedia stream can be better understood with reference to FIG. 8.

In FIG. 8, a flow diagram illustrating a method of identifying properties of a received multimedia stream is shown, according to one embodiment of the present invention. In one embodiment, the flow illustrated in FIG. 8 describes steps performed in step 330 of FIG. 7. In step 410, the microcode engine 131 is set to a first packet length. The packet length identifies an amount of bytes used for each packet of data in the received multimedia stream. For example, MPEG-2 multimedia streams can be organized into 188-byte packets, without forward error correction, and some digital satellite multimedia streams can be organized into 130-byte data packets. However, other parameters, in addition to packet lengths, may be necessary to identify the protocol, or packet type of the received multimedia stream.

In step 420, the microcode engine 131 is set to a first interface parameter. The first interface parameter identifies a particular parameter that could identify a property of the protocol of the received multimedia stream. The parameter can include, but is not limited to a type of data received, such as serial or parallel data, a polarity of a data validation signal to be used, or a type of active edge, such as a rising edge or a falling edge, of a clock signal used to trigger an input process of received data. The identified parameter can also include the use of an explicit data error signal sent from a front-end tuner device. A particular start code being used can be tested to determine if the proper protocol has been identified.

In step 430, the microcode engine 131 is set to a first start code. In step 440, it is determined if a lock has been achieved. In one embodiment, the microcode engine 131 attempts to read data packets of the received multimedia stream, based on the particular start code, packet length, and other interface parameters to test the selected packet type. If the microcode engine 131 is capable of identifying the data packets, the current settings identified by the microcode engine 131 are properties of the received multimedia stream and the flow proceeds to step 350 of FIG. 7. Alternatively, if the microcode engine 131 is not capable of identifying the data packets, the flow proceeds to step 450.

In step 450, it is determined if all known start codes have been tested. If start codes, known by the microcode engine 131, exist that haven't been tested, the flow proceeds to step 455. In step 455, the microcode engine 131 is set to an untested start code and the flow proceeds to step 440 to attempt a test of the received multimedia stream using the untested start code. If all start codes have been tested in step 450, the flow proceeds to step 460.

In step 460, it is determined if all interface parameters have been tested on the received multimedia stream. If untested interface parameters exist, the flow proceeds to step 465. In step 465, the microcode engine 165 is set to an alternate, untested interface parameter. The flow then proceeds to step 430, to allow the start codes to be tested using the alternate interface parameter. If all interface parameters have been tested in step 460, the step proceeds to step 470.

In step 470, it is determined if all known packet lengths have been tested on the received multimedia stream. If not all the known packet lengths have been tested, the flow proceeds to step 475. In step 475, he microcode engine 131 is set to an alternate packet length. The flow then proceeds to step 420 to allow the microcode engine to begin setting interface parameters for testing the received multimedia stream using the alternate packet length. If all packet lengths have been tested in step 470, then all known packet properties have been tested on the received multimedia stream without achieving a lock. In the illustrated embodiment, the microcode engine 131 determines a failure to identify the current packet type of the received multimedia stream has occurred and the flow proceeds to step 340 of FIG. 7.

Referring back to FIG. 7, if testing of the multimedia stream in step 330 fails, the flow proceeds to step 340. In step 340, the microcode engine 131 is set to an alternate packet type and returns to step 330 to test the received multimedia stream using the alternate packet type. In one embodiment, testing continues despite whether all packet types have already been tested. As a different or new multimedia stream may be received later, the system can continue testing until a known packet type is received. For example, in the case of a multimedia tuner, if the tuner selects an alternate multimedia stream or tunes to an alternate network source, a second multimedia stream, different than the first, received multimedia stream, may be received. Accordingly, the second multimedia stream may include a second protocol, different than a first protocol of the first, received multimedia stream. Alternatively, the system can stop testing until the test is triggered by another event, such as a system reset, a cable disconnect/connect, or until a user provides an indication to retest the received multimedia stream. If testing performed in step 330 is successful, the flow proceeds to step 350. In one embodiment, successful testing is based on if the system was able to identify the packet type of the received multimedia stream., such as by achieving a lock or identifying received data packets.

In step 350, a channel database, such as channel database 164 of FIG. 5, is updated to indicate the identified packet type of the received multimedia stream. In step 360, the received multimedia stream data is stored in memory, such as memory 160 of FIG. 5. The stored data of the received multimedia stream can be parsed using the packet type and properties stored in the database. The database can also be used to store other information regarding data parsed from the received multimedia stream, assisting other components of a multimedia processing system to process data associated with the received multimedia stream.

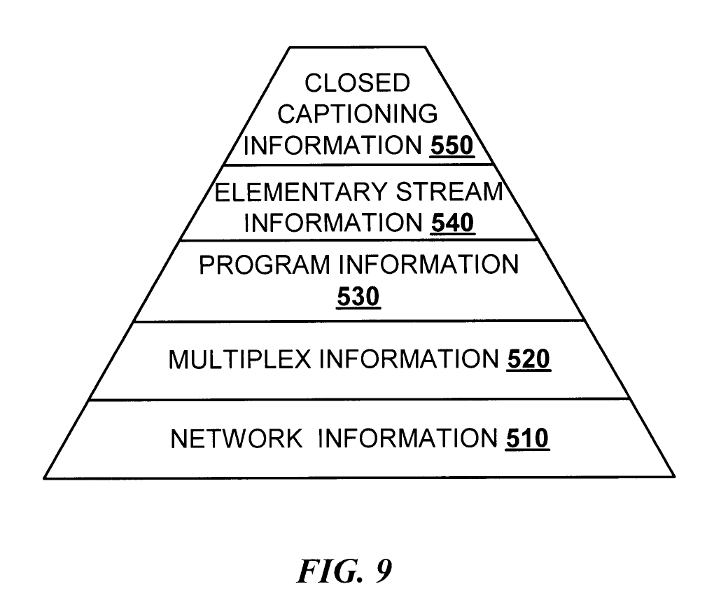

Referring now to FIG. 9, a block diagram illustrating hierarchal levels for organizing program properties is shown, according to one embodiment of the present invention. As previously discussed, a database, such as channel database 164 of FIG. 5, can be used to store information regarding properties of received multimedia streams and programs within received multimedia streams. In one embodiment, the information stored in the database is organized hierarchically as shown in FIG. 9.

In one embodiment, the highest level of the database is the network information level 510. The network information level 510 provides information describing protocols for identifying a multimedia network, such as network sources 105 of FIG. 5. The data defined in the network information level 510 can be provided to a multimedia source, such as multimedia tuner 110 of FIG. 5, to access a network carrying multiplexed multimedia streams.

In the illustrated embodiment, the multiplex information level 520 provides information regarding protocols of received data streams, such as packet length and start code information. In one embodiment, the multiplex information level 520 includes multimedia stream identifiers, as described in Table 1, for each multimedia stream of each network source identified in the network information level 510.

TABLE 1
Multiplex Information Identifiers

| MULTIPLEX DESCRIPTOR | DESCRIPTION |
|---|---|
| TRANSPORT STREAM | UNIQUELY IDENTIFIES |
| IDENTIFIER | MULTIPLEXED MULTIMEDIA |
| | STREAM |
| PROGRAM IDENTIFIERS | LISTS OF PROGRAMS WITHIN |
| | A MULTIPLEXED MULTIMEDIA |
| | STREAM |
| PRIVATE DATA LENGTH | LENGTH OF PRIVATE DATA |
| PRIVATE DATA | PRIVATE DATA PROVIDED IN |
| | A MULTIPLEXED MULTIMEDIA |
| | STREAM |
| NUMBER OF PROGRAMS | THE NUMBER OF PROGRAMS |
| | IN A MULTIPLEXED |
| | MULTIMEDIA STREAM |

Multiplexed multimedia streams include a collection of programs. In one embodiment, a program information level 530, lower than the multiplex information level 520. The program information level 530 provides information describing properties for each program of each multiplexed multimedia stream identified in the multiplex information level 520. Table 2 describes identifiers associated with the program information level 530, according to one embodiment of the present invention.

TABLE 2
Program Information Identifiers

| PROGRAM | |
|---|---|
| DESCRIPTOR | DESCRIPTION |
| PROGRAM | UNIQUE IDENTIFIER FOR A |
| NUMBER | PROGRAM |
| PCR PID | PROVIDES IDENTIFIER FOR |
| | LOCATING PROGRAM CLOCK |
| | REFERENCES FOR A |
| | PROGRAM |
| VIDEO PID | PROVIDES IDENTIFIER FOR |
| | LOCATING VIDEO DATA FOR |
| | A PROGRAM |
| AUDIO PID | PROVIDES IDENTIFIER FOR |
| | LOCATING AUDIO DATA FOR |
| | A PROGRAM |
| NUMBER OF | THE NUMBER OF PROGRAMS |
| PROGRAMS | IN EACH MULTIPELXED |
| | MULTIMEDIA STREAM |

Programs include a collection of elementary streams of data. In one embodiment, the database includes elementary stream information level 540, lower than the program information level 530. The elementary stream information level 540 includes information for describing each of the elementary streams for each program identified in the program information level 530. Table 3 describes identifiers in the elementary stream information level for each elementary stream.

TABLE 3
Elementary Stream Information Identifiers

| ELEMENTARY | |
|---|---|
| STREAM | |
| DESCRIPTOR | DESCRIPTION |
| STREAM TYPE | IDENTIFIES A TYPE OF AN ELEMETARY |
| | STREAM |
| ELEMENTARY | PROVIDES A UNIQUE IDENTIFIER FOR AN |
| PID | ELEMENTARY STREAM |
| VARIABLE RATE | INDICATES IF THE ELEMENTARY STREAM |
| AUDIO | INCLUDE AUDIO DATA HAVING |
| INDICATOR | VARIABLE RATES |
| ALIGNMENT | IDENTIFIES TYPE OF DATA STREAM |
| TYPE | ALIGNMENT ASSOCIATED WITH AN |
| | ELEMENTARY STREAM |
| CA PID | PROVIDES AN IDENTIFIER FOR |
| | CONDITIONAL ACCESS DATA |
| | ASSOCIATED WITH AN |
| | ELEMENTARY STREAM |
| NUMBER OF | IDENTIFIES A NUMBER OF CLOSED |
| CAPTION | CAPTIONING SERVICES ASSOCIATED |
| SERVICES | WITH AN ELEMENTARY STREAM |

In one embodiment, elementary streams are associated with sets of closed captioning data. A closed captioning information level 550, lower than the elementary stream information level 540, includes closed captioning data for particular elementary streams identified in the elementary stream level 540. It should be appreciated that levels of information can be included in the database in place of or in addition to the ones described without departing from the scope of the present invention.

The descriptors stored in the database can be used to assist components of a system in identifying multimedia stream properties. For example, a component of a multimedia system attempting to identify closed captioning data for a particular program does not have to parse data of the multimedia stream associated with the program to identify the closed captioning data. Stream engine 185 of FIG. 5 can identify the closed captioning data by accessing data in the database levels 510-550. The stream engine 185 accesses the network information level 510, to identify a proper multiplex to access in multiplex information level 520. The multiplex information is used to identify a proper program from program information level 530. The program information is used to identify information for a desired elementary stream using the elementary stream information level 540. The elementary stream information is used to access desired closed captioning data from the closed captioning information level 550.

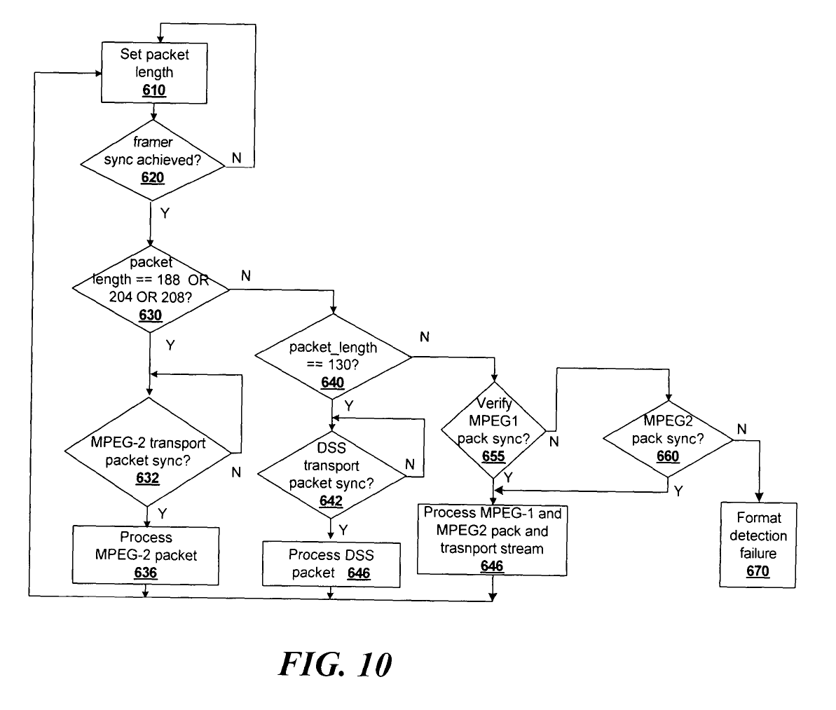

Referring now to FIG. 10, a flow diagram illustrating steps to identify a type of multimedia stream received is shown, according to one embodiment of the present disclosure. In one embodiment, the steps illustrated in FIG. 10 illustrate a method performed by transport stream demultiplexor 130 of FIG. 5 to identify unique types of multimedia streams. It should be noted that the steps illustrated in FIG. 10 identify a method of processing a multiplexed data stream of a multimedia stream of an unknown protocol. Furthermore, the steps of FIG. 10 can be performed on a single pass of the multiplexed data stream.

In step 610, a start code and packet length are identified from a received multimedia stream and stored in a register associated with the received multimedia stream. In step 620, it is determined if framer synchronization has been achieved with the received multimedia stream. If framer synchronization has not been achieved, the flow returns to step 610. If framer synchronization is achieved in step 620, the flow proceeds to step 630. In step 630, it is determined if the packet length associated with the received multimedia stream, as identified in step 610, is of a value equal to 188 bytes, 204 bytes or 208 bytes. If the packet length is equal to 188 bytes, 204 bytes or 208 bytes, the received multimedia stream is identified as an MPEG-2 transport packet and the flow proceeds to step 632. In step 632, the transport stream demultiplexor 130 waits until MPEG-2 transport packet synchronization is achieved. If MPEG-2 transport packet synchronization is not achieved, the flow remains in step 632. Once the MPEG-2 transport packet synchronization is achieved, the flow proceeds to step 636. In step 636, the MPEG-2 transport packet is processed. It should be appreciated that methods of processing MPEG-2 transport packets are known in the art and the method of processing MPEG-2 transport packets can be selected without departing from the scope of the present invention.

If the packet length identified in step 630 is not equal to 188, 204 or 208 bytes, the flow proceeds to step 640. In step 640, it is determined if the packet length of the received multimedia stream is equal to 130 bytes. If the packet length of the received multimedia stream is equal to 130 bytes, the packet of the received multimedia stream is identified as associated with DSS formatted transport packets and the flow proceeds to step 642. In step 642, the transport stream demultiplexor 130 waits until DSS transport packet synchronization is achieved. If DSS transport packet synchronization is not achieved, the flow remains in step 642. Once DSS transport packet synchronization is achieved, the flow proceeds to step 646. In step 646, the packet of the received multimedia stream is processed as a DSS transport packet. It should be appreciated that methods of processing DSS transport packets are known and a method of processing a DSS transport packet can be selected without departing from the scope of the present invention.

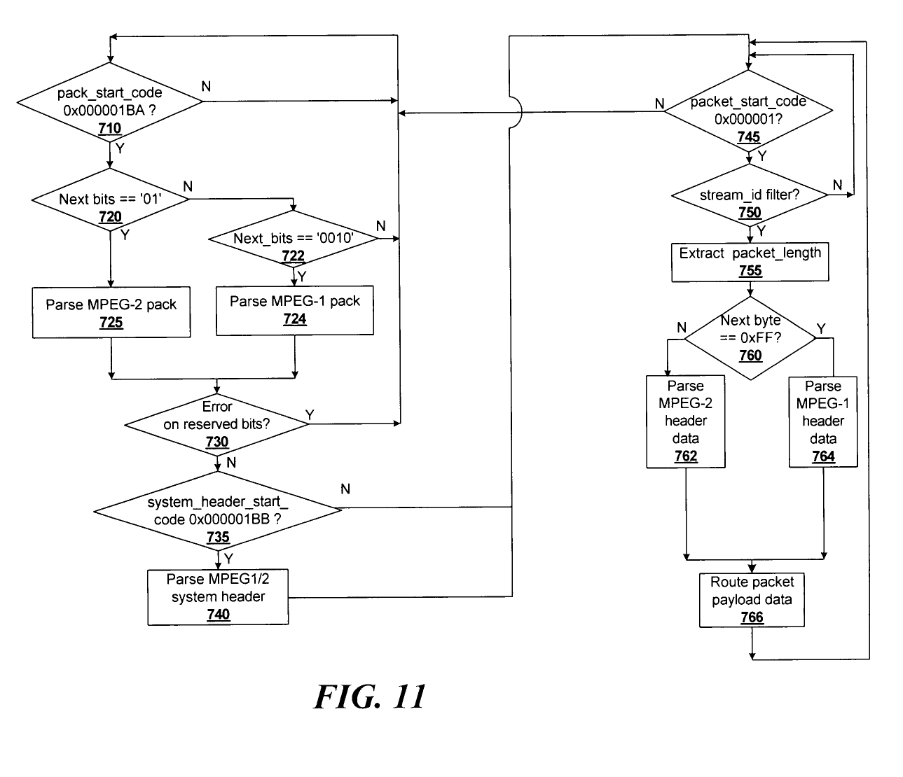

If the packet length identified in step 640 is not equal to 130 bytes, the flow proceeds to step 655. In step 655, the transport stream demultiplexor 130 verifies MPEG-1 pack synchronization. If MPEG-1 pack synchronization is achieved, the flow proceeds to step 671. In step 671, the packet of the received multimedia stream is processed as an MPEG-1 pack or program stream. If the MPEG-1 pack synchronization is not achieved in step 655, the flow proceeds to step 660. In step 660, the transport stream demultiplexor verifies MPEG-2 pack synchronization for the received pack. If the received pack is not MPEG-2 pack synchronized in step 660, the flow proceeds to step 670. In step 670, the transport stream demultiplexor fails to identify the received multimedia stream. It should be appreciated that other forms of multimedia streams may further be identified in step 670 without departing from the scope of the present invention. If the transport stream demultiplexor successfully verifies MPEG-2 pack synchronization in step 660, the flow proceeds to step 671 where the packet of the received multimedia stream is processed as an MPEG-2 pack or program stream packet. FIG. 11 illustrates a method of processing MPEG-1 and MPEG 2 pack and program stream packets as discussed in reference to step 671. Once processing performed with respect to steps 636, 646 and 671 is complete, the flow returns to step 610.

Referring now to FIG. 11, a method of processing MPEG-1 and MPEG pack and program stream packets is shown, according to one embodiment of the present invention. In one embodiment, the flow of FIG. 11 further describes processing to be performed by transport stream demultiplexor 130 of FIG. 5, as discussed in reference to step 671 of FIG. 10. It should be noted that the steps of FIG. 11 illustrate identification and processing of a received multiplexed data stream having an unknown protocol using a single pass of the received multiplexed data stream.

In step 710, it is determined if a pack start code associated with the received packet is equal to a hexadecimal value of 0x000001BA. If the pack start code is not equal to a hexadecimal value of 0x000001BA, the flow returns to step 710 until a proper pack start code is received. If the pack start code identified in step 71—is equal to a hexadecimal value of 0x000001BA, the flow proceeds to step 720. In step 720, it is determined if the two bits following the pack start code are equal to a binary value of ‘01’. If the two bits are equal to a binary value of ‘01’, it is determined the received packet is associated to an MPEG-2 pack, and the flow proceeds to step 725. In step 725, the MPEG-2 pack is parsed. In one embodiment of the present invention, processing in step 725 includes extracting an SCR, reserved bits, program multiplex rate, and a pack stuffing length associated with the received MPEG-2 pack identified in step 720. In one embodiment, the pack stuffing bytes associated with the identified MPEG-2 pack are ignored in step 725. Returning to step 720, if the two bits following the pack start code are not equal to a binary value of 01’, the flow returns to step 722. In step 722, it is determined if the next four bits are equal to a binary value of ‘0010’. If the next four bits are equal to a binary value of ‘0010’, the flow returns to step 710. If the next four bits identified in step 722 are equal to a binary value of ‘0010’, the received pack is associated with an MPEG-1 pack and the flow proceeds to step 724. In step 724, the transport stream demultiplexor processes the received pack as an MPEG-1 pack. In one embodiment of the present invention, the parsing performed in step 724 includes extracting a value of an SCR, reserved bits, and a program multiplex rate associated with the identified MPEG-1 pack. In one embodiment, once processing performed in steps 725 and 724 are complete, the flow proceeds to step 730.

In step 730, it is determined if an error flag is identified in the reserved bits extracted in either step 725 or step 724. If an error is identified from the reserved bits, the flow returns to step 710. If an error is not identified in the reserved bits in step 730, the flow proceeds to step 735. In step 735, it is determined if a system header start code of the received packet is equal to a hexadecimal value of 0x000001BB. If the system header start code is not equal to a hexadecimal value of 0x000001BB, the flow proceeds to step 745. If the system header start code is equal to a hexadecimal value of 0x000001BB, the flow proceeds to step 740. In step 740, the transport stream demultiplexor extracts a header length, a rate, and video and audio bounds identified in a system header associated with the received pack. In one embodiment, further header data is extracted to identify a list of stream identifiers, a system target decoder (STD) buffer size and STD scale data. The extracted header data can be used to allocate a proper amount of memory out of a frame buffer for a downstream decoding device. Once processing performed in step 740 is complete, the flow proceeds to step 745.

In step 745, it is determined if a packet start code of a received packet is equal to a hexadecimal value of 0x000001. If the packet start code of the received packet is not equal to a hexadecimal value of 0x000001, the flow returns to step 710. If the packet start code identified in step 745 is equal to a hexadecimal value of 0x000001, the flow proceeds to step 750. In step 750, it is determined if a stream identifier associated with the received pack is filtered. Filtering on a stream identifier, or stream_id, can be used for selection of elementary streams. For example, in one embodiment, values of a stream_id having a hexadecimal value in a range of 0xC0 to 0xDF hexadecimal values can be used to select one out of 32 particular audio streams and hexadecimal values in a range of 0xE0 to 0xEF can be used to select a particular MPEG1 video stream. Multiple video and audio streams may exist within a pack structure to facilitate selection of alternate scenes or viewing of the same scene but from a different angle. Filtering on the stream_id can be used to select between the multiple video and audio streams.

In step 760, it is determined if a next byte has a value equal to a hexadecimal 0xFF. If the next byte does not have a value equal to a hexadecimal value of 0xFF, it is determined the received packet is associated with MPEG-2 data and the flow proceeds to step 762. In step 762, the transport stream demultiplexor parses optional MPEG-2 header data. In one embodiment, parsing performed in step 762 includes extracting an STD, buffer size and scale data, and a PTS. In one embodiment, DTS data is also extracted in addition to the PTS data. In one embodiment, processing performed in step 762 includes ignoring stuffing data associated with the optional MPEG-2 header data.

Returning to step 760, if it is determined the next byte has a value equal to hexadecimal value of 0xFF, it is determined the received packet is associated with MPEG-1 data, and the flow proceeds to step 764. In step 764, the transport stream demultiplexor parses optional MPEG-1 header data associated with the received packet. In one embodiment, processing associated with step 764 includes, extracting an STD, buffer size and scale data, and a PTS. In one embodiment, DTS data is extracted in addition to the PTS data. In one embodiment, processing performed in step 764 includes an option to ignore stuffing data associated with the received packet.

In one embodiment of the present invention, once processing performed in steps 762 and 764 is complete, the flow proceeds to step 766. In step 766, the transport stream demultiplexor routes the packet payload data identified with the received packet. The flow then returns to step 745. It should be appreciated that the flow illustrated with respect to FIG. 11 represents one method of exploiting similarities between MPEG-1 and MPEG-2 data to process both MPEG-1 and MPEG-2 data using a single methodology. It should be appreciated that other methods of processing MPEG-1 and MPEG-2 data may be used without departing from the scope of the present invention.

1. A method comprising the steps of:
receiving a first data stream of multimedia data, wherein the multimedia data includes a first protocol and further wherein the first protocol is unknown;
determining, based upon a first portion of the first data stream, the first protocol of the multimedia data.

2. The method as in claim 1, wherein the first protocol is one of a set of predefined protocols comprising MPEG-2, Direct TV, and DVD protocols.

3. The method as in claim 1, further comprising:
storing a second portion of the first data stream in memory after the step of determining the first protocol.

4. The method as in claim 3, wherein the second portion of the first data stream is received after the first portion of the first data stream.

5. The method as in claim 3, wherein the second portion of the first data stream includes the first portion of the first data stream.

6. The method as in claim 3, further comprising generating a database based on the second portion.

7. The method as in claim 6, further comprising parsing the second portion of the first data stream to determine a first set of descriptors associated with the first data stream.

8. The method as in claim 7, wherein the first set of descriptors includes a descriptor from the set of descriptors comprising a network identifier, multiplex information, and program information.

9. The method as in claim 8, wherein multiplex information includes transport stream identifiers and program identifiers.

10. The method as in claim 8, wherein the program information includes program numbers, program recovery clock identifiers, video data identifiers and audio data identifiers.

11. The method as in claim 8, wherein the set of descriptors further includes elementary stream information and closed captioning information.

12. The method as in claim 11, wherein the elementary stream information includes data stream types and elementary stream identifiers.

13. The method as in claim 1, wherein the memory includes a frame buffer.

14. The method as in claim 1, further comprising:
receiving a second data stream of multimedia data, different from the first data stream, wherein the multimedia data of the second data stream includes a second protocol, different from the first protocol and further wherein the second protocol is unknown;
determining, based upon a first portion of the second data stream, the second protocol of the multimedia data of the second data stream.

15. A multimedia processing system comprising:
a first memory;
a second memory;
a microcode engine to:
receive a first transport stream;
identify a packet type associated with said first transport stream;
store said first transport stream in said first memory; and
a stream engine to store said packet type in said second memory.

16. The multimedia processing system as in claim 15, wherein said first memory and said second memory are part of a same memory.

17. The multimedia processing system as in claim 16, wherein said first memory and said second memory are part of a frame buffer.

18. The multimedia processing system as in claim 15, wherein the first memory and the second memory are part of separate memories.

19. The multimedia processing system as in claim 15, wherein said second memory includes a database of descriptors used to identify data of the first transport stream.

20. The multimedia processing system as in claim 19, wherein said stream engine further used to parse data of said first transport stream stored in first memory to identify said descriptors.

21. The multimedia processing system as in claim 20, wherein said descriptors include descriptors to identify network information, multiplex information and program information.

22. The multimedia processing system as in claim 15, further comprising a multimedia tuner to:
receive a network source signal;
identify a network type; and
provide said first transport stream based on said network type.

23. The multimedia processing system as in claim 22, wherein said stream engine is further used to store said network type in said second memory.

24. The multimedia processing system as in claim 15, wherein said stream engine further used to identify properties of a second received transport stream based on said second memory; and
set said microcode engine to process said second received transport stream based on said properties.

25. A method comprising the steps of:
receiving a multiplexed data stream of multimedia data, wherein the multimedia data includes an unknown protocol;
attempting to process the multiplexed data stream based on a first protocol;
when the step of attempting to process the multiplexed data stream based on the first protocol is successful:
storing data associated with the multiplexed data stream of multimedia data in memory;
associating the first protocol with the multiplexed data stream;
when the step of attempting to process the multiplexed data stream based on the first protocol is not successful:
attempting to process the multiplexed data stream based on a second protocol.

26. The method as in claim 25, wherein memory includes a frame buffer.

27. The method as in claim 25, wherein successful processing of the multiplexed data stream includes locking to the multiplexed data stream.

28. The method as in claim 25, wherein successful processing of the multiplexed data stream includes identifying data packets of the multiplexed data stream.

29. A method of identifying a multiplexed data stream of multimedia data comprising:
receiving a first portion of the multiplexed data stream of multimedia data, wherein the multimedia data includes an unknown protocol;
determining a packet length associated with the first portion of the multiplexed data stream;
when the packet length is one of a first set of packet lengths, associating a second portion of the multiplexed data stream with a first protocol; and
when the packet length is one of a second set of packet lengths, associating the second portion of the multiplexed data stream with a second protocol.

30. The method as in claim 29, wherein the step of determining a packet length includes identifying a value of a packet length identifier associated with the first portion of the multiplexed data stream.

31. The method as in claim 29, wherein the first set of packet lengths includes 188 bytes, 204 bytes or 208 bytes.

32. The method as in claim 29, wherein the second set of packet lengths includes 130 bytes.

33. The method as in claim 29, wherein the first protocol includes a Motion Picture Experts Group 2 transport packet protocol.

34. The method as in claim 29, wherein the second protocol includes Digital Satellite System protocols.

35. The method as in claim 29, further including the step of associating the second portion of the multiplexed data stream with a third protocol when the packet length is not of the first set of packet lengths or the second set of packet lengths.

36. The method as in claim 35, wherein the third protocol includes Motion Picture Experts Group 1 protocols.

37. A method of identifying a multiplexed data stream of a multimedia stream having an unknown protocol comprising:
receiving a first portion and a second portion of the multiplexed data stream;
identifying a value of the first portion of the multiplexed data stream;
receiving a third portion of the multiplexed data stream;
when the value of the second portion of the multiplexed data stream is of a first value, processing the third portion of the multiplexed data stream using a first protocol; and
when the value of the second portion of the multiplexed data stream is of a second value, processing the third portion of the multiplexed data stream using a second value.

38. The method as in claim 37, wherein the first portion of the multiplexed data stream includes a pack start code identifier.

39. The method as in claim 38, wherein the value of the first portion includes a hexadecimal value of 0x000001BA.

40. The method as in claim 39, wherein the first value includes a binary value of 01.

41. The method as in claim 40, wherein the first protocol includes a Motion Picture Experts Group 2 pack protocol data.

42. The method as in claim 41, wherein the step of processing the third portion of the multiplexed data stream using the first protocol includes parsing Motion Pictures Experts Group 2 pack data associated with the third portion.

43. The method as in claim 39, wherein the second value includes a binary value of 0010.

44. The method as in claim 43, wherein the first protocol includes a Motion Picture Experts Group 1 pack protocol data.

45. The method as in claim 44, wherein the step of processing the third portion of the multiplexed data stream using the first protocol includes parsing Motion Pictures Experts Group 1 pack data associated with the third portion.
